(19) United States
(12) Patent Application Publication
(10) Pub. No.: US 2015/0277405 A1
(43) Pub. Date: Oct. 1, 2015

(54) PRODUCTION PLAN DISPLAY METHOD, PRODUCTION PLAN SUPPORT METHOD, PRODUCTION PLAN DISPLAY APPARATUS, PRODUCTION PLAN SUPPORT APPARATUS, AND RECORDING MEDIUM

(71) Applicant: FUJITSU LIMITED, Kawasaki-shi (JP)

(72) Inventors: Hirotaka ITO, kasugai (JP); Jun FUKAO, Ichinomiya (JP); Tatsuya ISHIHARA, Yokohama (JP)

(73) Assignee: FUJITSU LIMITED, Kawasaki (JP)

(21) Appl. No.: 14/628,735

(22) Filed: Feb. 23, 2015

(30) Foreign Application Priority Data
Mar. 31, 2014 (JP) 2014-073560

(51) Int. Cl. G05B 15/02; G06F 3/0484; G06T 11/20

(52) U.S. Cl. CPC G05B 15/02; G06T 11/206; G06F 3/0484

(57) ABSTRACT

A non-transitory computer-readable recording medium has stored therein a program that causes a computer to execute a production plan display process including: controlling a first display of arranging a plurality of production processes included in production processing of a particular product in an order of execution, the arrangement being associated with an order to produce the particular product, and at the same time, controlling a second display of arranging, for each production line planned to be used in the production processing of the particular product, each of production processes planned to be executed on a subject production line among the plurality of production processes at a time position corresponding to a time position where the production process is arranged in the first display.

### CROSS-REFERENCE TO RELATED APPLICATION

This application is based upon and claims the benefit of priority of the prior Japanese Patent Application No. 2014-073560, filed on Mar. 31, 2014, the entire contents of which are incorporated herein by reference.

### FIELD

The embodiments of the present invention are related to a production plan display program, a production plan support program, a production plan display method, a production plan support method, a production plan display apparatus, and a production plan support apparatus.

### BACKGROUND

There have been software applications for displaying a Gantt chart and editing work objects on the Gantt chart to manage a production plan of products or the like.

Patent Document 1: International Publication Pamphlet No. 2002/010872 is introduced as the Related Art Document.

Now, in a production division, each order is divided into a plurality of production steps, and work of each of the production steps are performed. Then, in some cases, the production division wants to know the work statuses of production lines performing the production steps, as well as the production steps for the order.

### SUMMARY

According to an aspect of the embodiments, a non-transitory computer-readable recording medium has stored therein a program that causes a computer to execute a production plan display process including: controlling a first display of arranging a plurality of production processes included in production processing of a particular product in an order of execution, the arrangement being associated with an order to produce the particular product, and at the same time, controlling a second display of arranging, for each production line planned to be used in the production processing of the particular product, each of production processes planned to be executed on a subject production line among the plurality of production processes at a time position corresponding to a time position where the production process is arranged in the first display.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of a schematic configuration of a system as a whole;

FIG. 2 is a diagram illustrating an example of a functional configuration of a production plan support apparatus;

FIG. 3 is a diagram illustrating an example of a data configuration of work information;

FIG. 4 is a diagram illustrating an example of a data configuration of facility information;

FIG. 5 is a diagram illustrating an example of a data configuration of item configuration information;

FIG. 6 is a diagram illustrating a production relationship between items;

FIG. 7 is a diagram illustrating an example of a production plan screen displaying a production plan;

FIG. 8 is a diagram illustrating an example of a production plan screen displaying, in a row, respective pieces of work of an order, and work plans of facilities to be used to perform the respective pieces work;

FIG. 9 is a diagram illustrating an example of a production plan screen displaying, in a row, respective pieces of work of an order, and work plans of facilities capable of producing items of the respective pieces of work of the order;

FIG. 10 is a flow chart illustrating an example of a procedure of display control processing; and

FIG. 11 is a diagram illustrating a computer that executes a production plan support program.

### DESCRIPTION OF EMBODIMENTS

Preferred embodiments will be explained with reference to accompanying drawings. It is noted that such embodiments are not intended to limit the invention. The respective embodiments may be combined as appropriate without a contradiction in processing contents.

### [a] First Embodiment

### Configuration of System

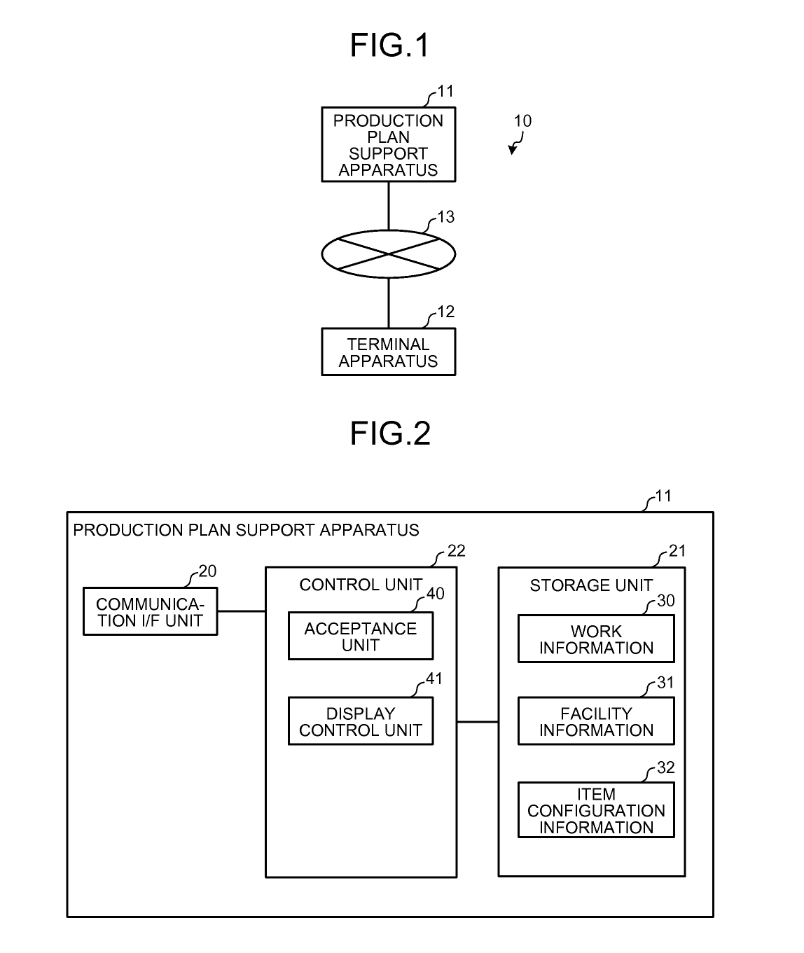

A system 10 according to a first embodiment will be described. FIG. 1 is a diagram illustrating an example of a schematic configuration of the entire system. As illustrated in FIG. 1, the system 10 is a system that supports the creation of a production plan of products or the like. The system 10 includes a production plan support apparatus 11, and a terminal apparatus 12. The production plan support apparatus 11 and the terminal apparatus 12 can exchange various types of information with each other. For example, the production plan support apparatus 11 and the terminal apparatus 12 are connected so that they can communicate with each other via a network 13 so that they can exchange various types of information with each other. As a mode of such a network 13, any type of communication network, wired or wireless, may be employed. Examples thereof may include mobile communications, such as a mobile phone, the Internet, a LAN (Local Area Network), and a VPN (Virtual Private Network).

The terminal apparatus 12 is a computer which an administrator who creates and manages a production plan uses to input and refer to a production plan. Examples of the terminal apparatus 12 may include a desktop PC (personal computer) and a notebook PC. The administrator uses the terminal apparatus 12 to transmit various operation instructions concerning a production plan to the production plan support apparatus 11, so as to create a production plan using the production plan support apparatus 11. Note that while the example of FIG. 1 illustrates a case where there is one terminal apparatus 12, the present invention is not limited to this, and there may be any number of terminal apparatuses 12.

The production plan support apparatus 11 is an apparatus that performs various types of processing concerning a production plan. Examples of the production plan support apparatus 11 may include a computer such as a server computer. The production plan support apparatus 11 may be implemented as a single computer, or may be implemented as a cloud of a plurality of computers. For example, the production plan support apparatus 11 may be implemented as an application server that executes various types of processing concerning a production plan and a database server that stores various types of information concerning the production plan. The production plan support apparatus 11 may be implemented as a standalone apparatus operated directly by the administrator. Note that the present embodiment will be described by using a case where the production plan support apparatus 11 is a single computer as an example. The production plan support apparatus 11 runs software applications for supporting the creation of a production plan, and performs processing according to requests received from the terminal apparatus 12. Then, the production plan support apparatus 11 generates information concerning processing results, such as image information indicating the result of performing processing, so as to transmit the information to the requesting terminal apparatus 12.

Configuration of Production Plan Support Apparatus

Next, a configuration of the production plan support apparatus 11 of the present embodiment will be described. FIG. 2 is a diagram illustrating an example of a functional configuration of the production plan support apparatus. As illustrated in FIG. 2, the production plan support apparatus 11 includes a communication I/F (interface) unit 20, a storage unit 21, and a control unit 22. The production plan support apparatus 11 may include various known functional units in addition to the functional units illustrated in FIG. 2. For example, the production plan support apparatus 11 may include an input unit that inputs various types of information, and a display unit that displays various types of information.

The communication I/F unit 20 is an interface responsible for controlling communications with other apparatuses. The communication I/F unit 20 transmits and receives various types of information to/from other apparatuses via the network 13. For example, the communication I/F unit 20 receives various operation instructions concerning a production plan from the terminal apparatus 12. The communication I/F unit 20 transmits image information indicating a result of performing processing according to the operation instructions to the terminal apparatus 12. A network interface card such as a LAN card may be employed as the communication I/F unit 20.

The storage unit 21 is a storage device that stores various types of data. Examples of the storage unit 21 may include storage devices such as a hard disk, an SSD (Solid State Drive), and an optical disk. Note that the storage unit 21 may be a data-rewritable semiconductor memory such as a RAM (Random Access Memory), a flash memory, and an NVSRAM (Non Volatile Static Random Access Memory).

The storage unit 21 stores an OS (Operating System) and various programs to be executed by the control unit 22. For example, the storage unit 21 stores various programs including a program for performing display control processing to be described later. Moreover, the storage unit 21 stores various types of data to be used by programs executed by the control unit 22. For example, the storage unit 21 stores work information 30, facility information 31, and item configuration information 32.

The work information 30 is data that includes information concerning various types of work to be performed by the production plan. For example, the work information 30 stores, for each piece of work to be performed, information such as items to be produced, facilities to perform the work, and a period of work.

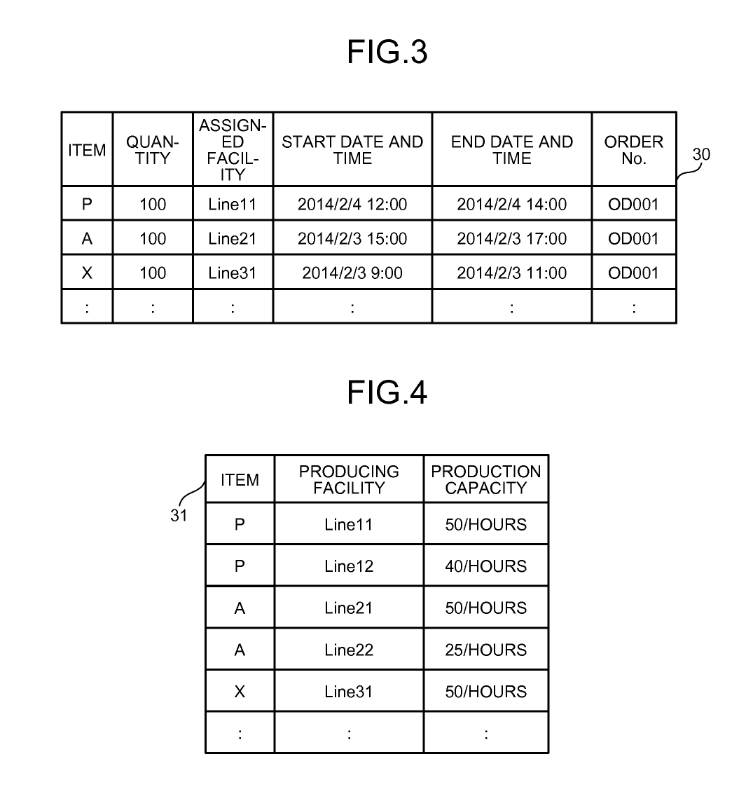

FIG. 3 is a diagram illustrating an example of a data configuration of the work information. As illustrated in FIG. 3, the work information 30 includes respective fields of “item,” “quantity,” “assigned facility,” “start date and time,” “end date and time,” and “order No.” The ‘item’ field is an area in which information indicating the item to be produced by the work is stored. In the ‘item’ field, information indicating an item, such as an item code thereof is stored. The ‘quantity’ field is an area in which the quantity of the item to be produced by the work is stored. The ‘assigned facility’ field is an area in which information indicating a facility to be used to perform the work is stored. The present embodiment uses information concerning the production line that produces a product as the information indicating the facility. The ‘start date and time’ field is an area in which the date and time to start the work is stored. The ‘end date and time’ field is an area in which the date and time to end the work is stored. The ‘order No.’ field is an area in which identification information for identifying an accepted order is stored. Each order is assigned a unique order number as identification information for identifying the order. In the ‘order No.’ field stored is the order number assigned to the order. Note that the work information 30 may include other fields to be set. For example, the work information 30 may contain a work No. for identifying each piece of work, and a field in which the production deadline is set.

In the example of FIG. 3, there is a plan for work of producing item “P” as many as the quantity “100” in the assigned facility “Line11” with the start date and time “2014/2/4 12:00” and the end date and time “2014/2/4 14:00,” and it is indicated that the order number is “OD001.” There is also a plan for work of producing item “A” as many as the quantity “100” in the assigned facility “Line21” with the start date and time “2014/2/3 15:00” and the end date and time “2014/2/3 17:00,” and it is indicated that the order number is “OD001.” There is also a plan for work of producing item “X” as many as the quantity “100” in the assigned facility “Line31” with the start date and time “2014/2/3 9:00” and the end date and time “2014/2/3 11:00,” and it is indicated that the order number is “OD001.”

Referring back to FIG. 2, the facility information 31 is data that contains information concerning facilities capable of producing each item. For example, the facility information 31 contains information concerning facilities capable of producing each item, and the production capacity thereof.

FIG. 4 is a diagram illustrating an example of a data configuration of the facility information. As illustrated in FIG. 4, the facility information 31 includes fields of “item,” “producing facility,” and “production capacity.” The ‘item’ field is an area in which identification information indicating an item, such as an item code thereof, is stored. The ‘producing facility’ field is an area in which information indicating a facility capable of producing the item is stored. The present embodiment uses information concerning the production line for producing a product as the information indicating a facility. The ‘production capacity’ field is an area in which information indicating the production capacity of the facility when producing the item is stored. As the information indicating the production capacity, the present embodiment uses the quantity that can be produced per unit time. Note that the information indicating the production capacity may be the amount of time requested for producing a single piece of product.

The example of FIG. 4 indicates that the quantity of item “P” that can be produced is 50 per unit time, when produced in the facility “Line11.” It is also indicated that the quantity of item “P” that can be produced is 40 per unit time, when produced in the facility “Line12.” It is also indicated that the quantity of item “A” that can be produced is 50 per unit time, when produced in the facility “Line21.” It is also indicated that the quantity of item “A” that can be produced is 25 per unit time, when produced in the facility “Line22.” It is indicated that the quantity of item “X” that can be produced is 50 per unit time, when produced in the facility “Line31.”

Now, as illustrated in FIG. 4, for the same item produced, the production capacity may differ between different production lines. For example, while item “P” can be produced either in the facility “Line11” or in the facility “Line12,” the facility “Line11” is capable of producing more per unit time than the facility “Line12.” While item “A” can be produced either in the facility “Line21” or in the facility “Line22,” the facility “Line21” is capable of producing more per unit time than the facility “Line22.” Note that a production line may be capable of producing different products. For example, a single facility may be capable of producing item “A” and item “A′.”

Referring back to FIG. 2, the item configuration information 32 is data that contains information concerning materials to be used for the production of each item. For example, the item configuration information 32 contains information concerning items constituting an item.

FIG. 5 is a diagram illustrating an example of a data configuration of the item configuration information. As illustrated in FIG. 5, the item configuration information 32 includes respective fields of “item,” “lower-order item,” “material unit numerator,” and “material unit denominator.” The ‘item’ field is an area in which identification information indicating an item, such as an item code thereof, is stored. The ‘lower-order item’ field is an area in which identification information of an item to be a material for producing the item is stored. The ‘material unit numerator’ field is an area in which the numerator of a fraction representing the proportion by which the lower-order item is used for producing the item is stored. The ‘material unit denominator’ field is an area in which the denominator of a fraction representing the proportion by which the lower-order item is used for producing the item is stored.

In the example of FIG. 5, item “A” is produced by using item “X,” as a material thereof, by the proportion represented by material unit numerator “1” and material unit denominator “1.” That is, item “A” is produced by using one unit of item “X” as a material. Moreover, item “P” is produced by using item “A,” as a material thereof, by the proportion represented by material unit numerator “1” and material unit denominator “1.” That is, item “P” is produced by using one unit of item “A” as a material. Note that while the example of FIG. 5 is directed to a case where an item is produced by using a single lower-order item, if there are a plurality of lower-order items, a record is registered for each of the lower-order items.

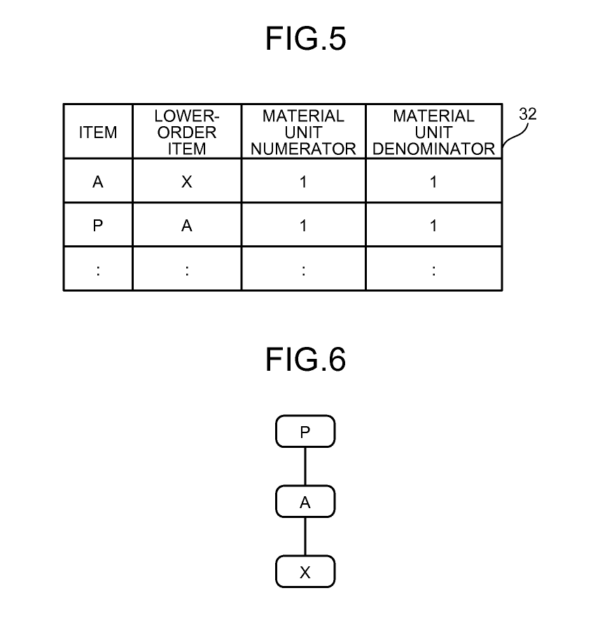

FIG. 6 is a diagram illustrating a production relationship between items. The example of FIG. 6 illustrates the production relationship between items illustrated in FIG. 5. In the example of FIG. 6, an item at a higher position is an item produced in a higher-order step. In the example of FIG. 6, item “A” is produced by using item “X.” Also in the example of FIG. 6, item “P” is produced by using item “A.”

Referring back to FIG. 2, the control unit 22 is a device that controls the production plan support apparatus 11. Electronic circuits such as a CPU (Central Processing unit) and an MPU (Micro Processing Unit) and integrated circuits such as an ASIC (Application Specific Integrated Circuit) and an FPGA (Field Programmable Gate Array) may be employed as the control unit 22. The control unit 22 includes an internal memory for storing programs and control data that define various processing procedures, and thereby performs various types of processing. With the operation of various programs, the control unit 22 functions as various processing units. For example, the control unit 22 includes an acceptance unit 40 and a display control unit 41.

The acceptance unit 40 performs various types of acceptance. For example, the acceptance unit 40 accepts various operation instructions concerning a production plan. For example, the acceptance unit 40 accepts various operation instructions concerning a production plan transmitted from the terminal apparatus 12.

The display control unit 41 performs display control on various screens. For example, the display control unit 41 makes the terminal apparatus 12 display various screens concerning a production plan. For example, the display control unit 41 makes the terminal apparatus 12 display a production plan screen displaying a production plan of products and the like in the form of a Gantt chart. For example, the display control unit 41 makes the terminal apparatus 12 display a production plan screen displaying, in the form of a Gantt chart, each piece of work for producing an ordered item for each order accepted. Then, the display control unit 41 updates the production plan screen to be displayed on the terminal apparatus 12 according to an operation instruction accepted by the acceptance unit 40.

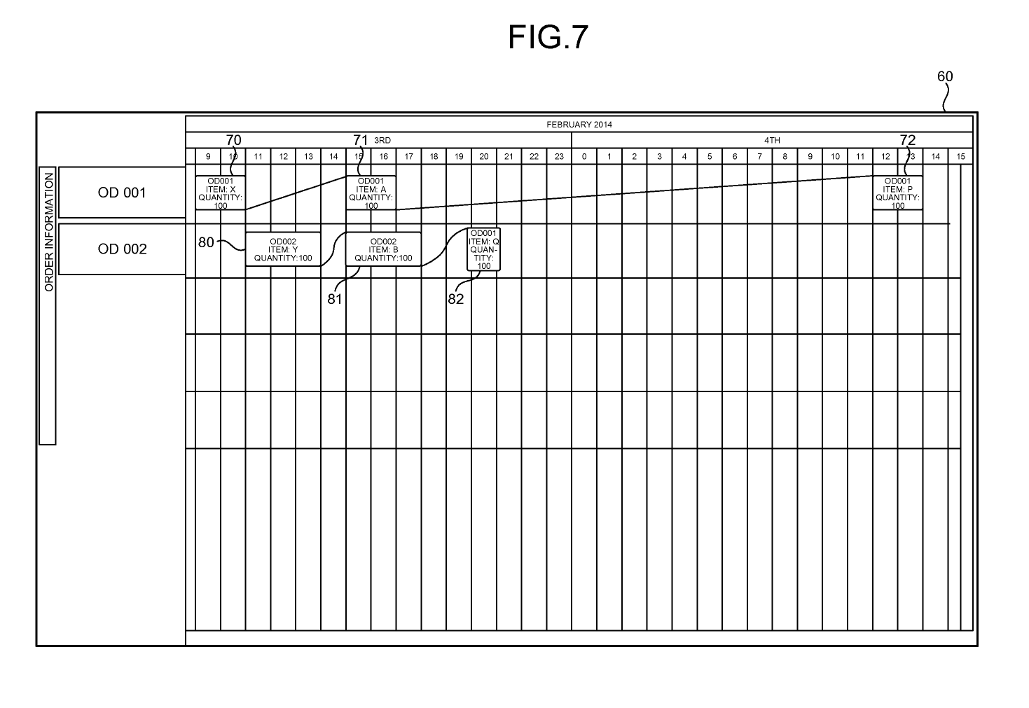

A description will be given by way of specific examples. FIG. 7 is a diagram illustrating an example of the production plan screen displaying a production plan. A production plan screen 60 displays, in the form of a Gantt chart, each piece of work for producing an ordered item for each order. The production plan screen 60 illustrated in FIG. 7 displays production plans for orders “OD001” and “OD002.” In the example of FIG. 7, work objects 70, 71 and 72, indicating work producing items, are displayed as the production plan for order “OD001.” In the example of FIG. 7, work objects 80, 81 and 82, indicating work for producing items, are displayed as the production plan for order “OD002.”

The work object 70 is related to order “OD001,” indicating work of producing item “X” as many as the quantity “100” between 2014/2/3 9:00 and 2014/2/3 11:00. The work object 71 is related to order “OD001,” indicating work of producing item “A” as many as the quantity “100” between 2014/2/3 15:00 and 2014/2/3 17:00. The work object 72 is related to order “OD001,” indicating work of producing item “P” as many as the quantity “100” between 2014/2/4 12:00 and 2014/2/4 14:00.

The work object 80 is related to order “OD002,” indicating work of producing item “Y” as many as the quantity “100” between 2014/2/3 11:00 and 2014/2/3 14:00. The work object 81 is related to order “OD002,” indicating work of producing item “B” as many as the quantity “100” between 2014/2/3 15:00 and 2014/2/3 18:00. The work object 82 is related to order “OD002,” indicating work of producing item “Q” as many as the quantity “100” between 2014/2/3 19:00 and 2014/2/3 20:00.

By performing a predetermined first operation while specifying the line of an order, the production plan screen 60 is capable of displaying, in a row, respective pieces of work of the order, and work plans of facilities to be used to perform these pieces of work.

When the first operation is performed, the display control unit 41 displays, in a row on the production plan screen 60, respective pieces of work of orders being specified, and work plans of facilities to be used to perform these pieces of work. For example, the display control unit 41 performs a first display control of displaying, on the production plan screen 60, a plurality of production steps included in the processing of producing the product of the order being specified, wherein the production steps are arranged in the order of execution. In addition to the first display, the display control unit 41 also performs a second display control, where for each production line planned to be used for producing the product of the order being specified, production steps planned to be executed on the subject production line among the plurality of production steps are displayed at time positions corresponding to those of the first display. For example, the display control unit 41 refers to the work information 30 to read out pieces of work to be carried out for the order being specified, and displays, on the production plan screen 60, work objects of the pieces of work of a plurality of steps for producing the product of the order being specified while the work objects are arranged in order. The display control unit 41 also refers to the work information 30 to extract pieces of work for each of the facilities to perform the pieces of work for producing the product of the order being specified, and displays, on the production plan screen 60, the extracted pieces of work for each facility while the extracted pieces of work are arranged in order.

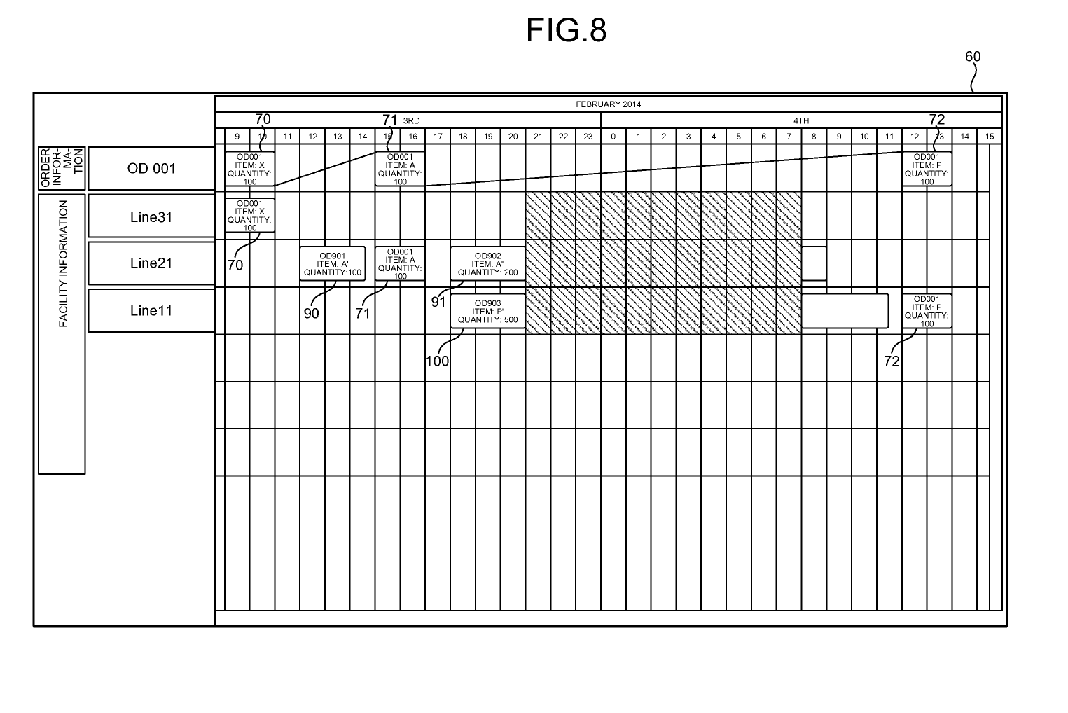

FIG. 8 is a diagram illustrating an example of a production plan screen displaying, in a row, respective pieces of work of an order, and work plans of facilities to be used to perform the pieces of work. FIG. 8 illustrates the result of performing the first operation while specifying order “OD001” on the production plan screen 60 as illustrated in FIG. 7. Note that if an idle period in which the facility is not operated or does not perform production is set for each facility, the display control unit 41 may display the work period in an identifiable manner, such as by graying them, excluding the idle period. For example, if an idle period in which a factory is at rest, like during nighttime, is set, the display control unit 41 may obtain the work period excluding the idle period and display the work period in an identifiable manner. In the example of FIG. 8, idle periods of facilities are hatched so that they can be identified. In the example of FIG. 8, the idle period is from 2014/2/3 21:00 to 2014/2/4 8:00.

The production plan screen 60 displays, on the first line, the work objects 70, 71 and 72 indicating pieces of work for producing the item of order “OD001” being specified. The production plan screen 60 also displays, each on a separate line, work plans of facilities which are to be used to perform the respective pieces of work for producing the item of order “OD001” being specified. In the example of FIG. 8, the work object 70 is displayed as a work plan for the facility “Line31” to be used to perform the work of the work object 70. In the example of FIG. 8, work objects 90 and 91 are displayed, together with the work object 71, as work plans of the facility “Line21” to be used to perform the work of the work object 71. The work object 90 is related to order “OD901,” indicating work of producing item “A′” as many as the quantity “100” between 2014/2/3 12:00 and 2014/2/3 14:30. The work object 91 is related to order “OD902,” indicating work of producing item “A″” as many as the quantity “200” between 2014/2/3 18:00 and 2014/2/4 9:00. In the example of FIG. 8, a work object 100 is displayed, together with the work object 72, as a work plan of the facility “Line11” to be used to perform the work of the work object 72. The work object 100 is related to order “OD903,” indicating work of producing item “P′” as many as the quantity “500” between 2014/2/3 18:00 and 2014/2/4 11:30.

As the pieces of work of an order and work plans of facilities to be used to perform the respective pieces of work are displayed in a row, the administrator can easily grasp the production plans of the production steps of performing the pieces of work of the order.

On the production plan screen 60, a production plan can be changed by moving a work object. The display control unit 41 updates the work information 30 concerning the moved work object in accordance with the moved position.

On the production plan screen 60, by performing a predetermined second operation while specifying the line of an order, it is possible to display, in a row, respective pieces of work of the order, facilities to be used to perform the respective pieces of work, and work plans of facilities to which the respective pieces of work can be assigned.

When the second operation is performed, the display control unit 41 performs a display control to display, on the production plan screen 60, work plans of facilities to which the respective pieces of work can be assigned, in addition to the pieces of work of the order being specified and the work plans of the facilities to be used to perform the pieces of work. For example, the display control unit 41 refers to the facility information 31 to read out facilities capable of producing items of pieces of work of the order, which items are registered in the ‘item’ field, thereby specifying the assignable facilities. Then, the display control unit 41 refers to the work information 30 to display, in a row on the production plan screen 60, respective pieces of work of the order being specified, the facilities to be used to perform the respective pieces of work, and work plans of facilities to which the respective pieces of work can be assigned.

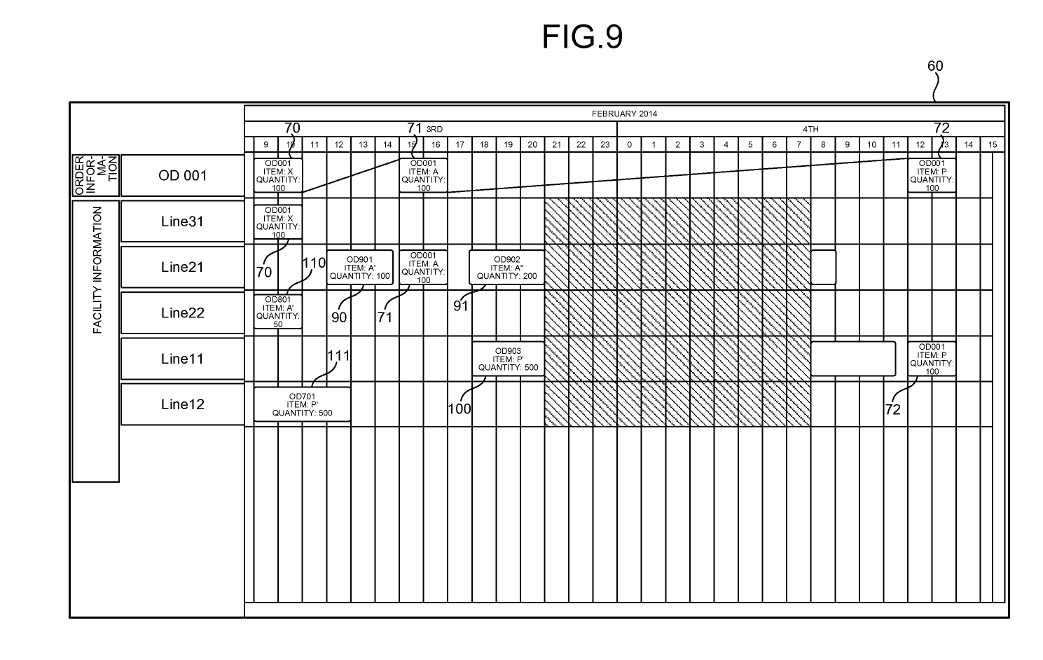

FIG. 9 is a diagram illustrating an example of a production plan screen displaying, in a row, respective pieces of work of an order, and work plans of facilities capable of producing items of the respective pieces of work of the order. FIG. 9 illustrates the result of performing the second operation while specifying order “OD001” on the production plan screen 60 as illustrated in FIG. 7. Also in the example of FIG. 9, idle periods of facilities are hatched so that they can be identified.

In the example of FIG. 9, a work object 110 is displayed as a work plan of the facility “Line22” to which the work of item “A” can be assigned, in addition to the example of FIG. 8. Also in the example of FIG. 9, a work object 111 is displayed as a work plan of the facility “Line12” to which the work of item “P” can be assigned. The work object 110 is related to order “OD801,” indicating work of producing item “A′” as many as the quantity “50” between 2014/2/3 9:00 and 2014/2/3 11:00. The work object 111 is related to order “OD701,” indicating work of producing item “P′” as many as the quantity “100” between 2014/2/3 9:00 and 2014/2/3 13:00.

On the production plan screen 60, a production plan can be changed by moving a work object. For example, the production plan screen 60 is configured such that a production plan can be changed by moving a work object to another facility to which the work of the work object can be assigned.

As an operation of moving a work object is received from the acceptance unit 40, the display control unit 41 moves the work object. For example, the display control unit 41 refers to the facility information 31 to specify the production capacity when producing the item of the arranged work object by using the facility at the position where the work object is arranged. Then, the display control unit 41 obtains the period for producing the item of the arranged work object in a specified quantity with the specified production capacity. For example, the display control unit 41 obtains the end date and time of the period for producing the item of the arranged work object in a specified quantity, while the position where the work object is arranged is regarded as the start date and time. Then, the display control unit 41 arranges the work object over a length determined in accordance with the obtained period. The display control unit 41 updates the work information 30 concerning the arranged work object in accordance with the position where the work object is arranged.

As the pieces of work of an order and work plans of facilities to which the respective pieces of work can be assigned are displayed in a row, the administrator can easily grasp the production plans of alternative facilities to which pieces of work can be assigned. When changing a production plan for an order, the administrator can assign work to a facility to which the work can be assigned, by using the production plan screen 60. For example, in the example of FIG. 9, the work object 90 can be moved to facility “Line22” to produce item “A′” in the facility “Line22,” thereby allowing the start of the work object 71 to be moved up to an earlier time. Also in the example of FIG. 9, the work object 72 can be moved to facility “Line12,” thereby allowing the start of the work object 72 to be moved up to an earlier time.

Flow of Processing

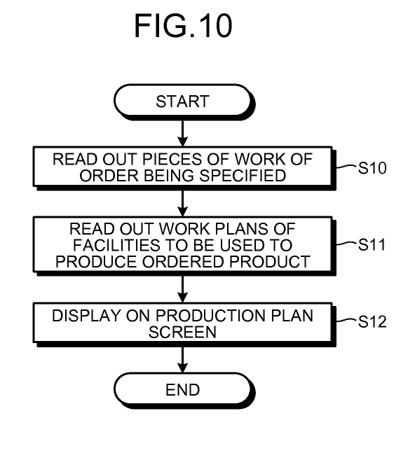

Next, various processing to be executed by the production plan support apparatus 11 according to the present embodiment will be described. First, the flow of the display control processing in which the production plan support apparatus 11 according to the present embodiment displays respective pieces of work of an order and work plans of facilities in a row will be described. FIG. 10 is a flow chart illustrating an example of a procedure of the display control processing. The display control processing is executed at a predetermined timing, for example, a timing at which the first operation or the second operation is performed on the production plan screen 60.

As illustrated in FIG. 10, the display control unit 41 refers to the work information 30 to read out pieces of work to be carried out for an order being specified (S10). The display control unit 41 refers to the work information 30 to read out work plans of facilities to be used to produce the product of the order being specified (S11). For example, when the first operation is performed, the display control unit 41 reads out, from the work information 30, other pieces of work of assigned facilities to be used to perform the pieces of work of the order being specified. When the second operation is performed, the display control unit 41 refers to the facility information 31 to read out facilities capable of producing registered items of respective pieces of work of the order, thereby specifying the assignable facilities, and read out, from the work information 30, other pieces of work of the assignable facilities. The display control unit 41 displays, in a row on the production plan screen 60, respective pieces of work of the order and the work plans of the facilities to be used to perform the respective pieces of work (S12), and ends the processing.

Effects

As described above, the production plan support apparatus 11 of the present embodiment performs a first display control of arranging a plurality of production steps included in the production processing of a particular product in the order of execution, the arrangement being associated with the order to produce the particular product. In addition to the first display, the production plan support apparatus 11 also performs a second display control of arranging, for each production line planned to be used in the production processing of the particular product, each of production steps planned to be executed on a subject production line among the plurality of production steps at a time position corresponding to the time position where it is arranged in the first display. Thus, the production plan support apparatus 11 can make it possible to easily grasp production plans of production steps of performing the pieces of work of the order.

For example, with the production plan support apparatus 11 of the present embodiment, based on order information for the production of a certain product, work for producing the certain product is divided into a plurality of steps, and the facility and the time slot to be used to perform the pieces of work of the plurality of steps are stored in the storage unit 21. The production plan support apparatus 11 detects an instruction to display production information for order information for the production of a certain product by using a diagram in which the start date and time and the end date and time of the work of each step are expressed by an area with one axis as the time axis. When the instruction is detected, the production plan support apparatus 11 refers to the storage unit 21 to arrange each of the plurality of steps for producing the certain product for the order information in the diagram, extract and arrange each of the lines on which the plurality of steps are performed, and output the result of arrangement. Thus, the production plan support apparatus 11 can make it possible to easily grasp production plans of respective production steps of performing the pieces of work of the order.

When an instruction to display assignable facilities is detected, the production plan support apparatus 11 according to the present embodiment extracts and displays lines to which the steps can be assigned. Thus, the production plan support apparatus 11 can make it possible to easily grasp production plans of alternative facilities to which pieces of work can be assigned.

### [b] Second Embodiment

While an embodiment of the apparatus disclosed herein has been described above, the technique disclosed herein may be carried out in various forms other than the embodiment described above. In view of this, other embodiments encompassed by the present invention will be described below.

For example, while the embodiment described above is directed to a case where the production plan support apparatus 11 is a single computer, it may be implemented as a server that performs a display control and a server that stores various types of information. The server that performs a display control corresponds to the production plan display apparatus.

Various components of various apparatuses illustrated in the drawings are functional, conceptual ones, and do not need to be physically configured as illustrated in the drawings. That is, the specific states of the apparatuses, whether distributed or integrated, are not limited to the illustrated ones. All or part of the apparatuses may be configured to be functionally or physically distributed or integrated in arbitrary units according to various loads and use conditions. For example, different processing units, such as the acceptance unit 40 and the display control unit 41, may be integrated together as appropriate. The processing of each processing unit may be divided into that of a plurality of processing units as appropriate. All or any part of processing functions performed by the processing units may be implemented by a CPU and a program interpreted and executed by the CPU. All or any part of such processing functions may be implemented as hardware by wired logic.

Production Plan Support Program

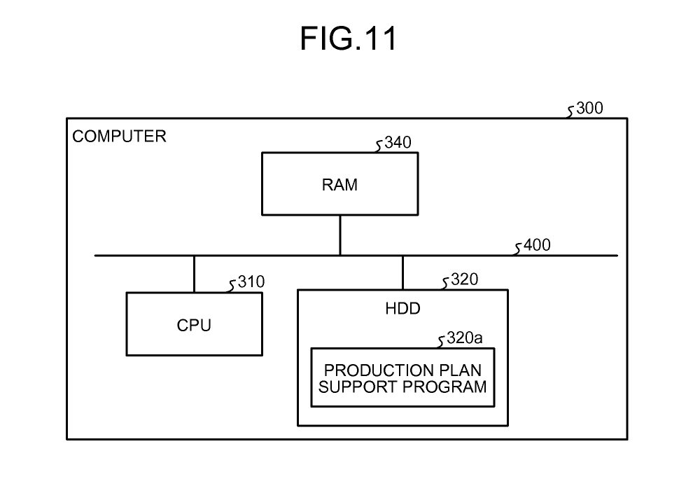

Various types of processing described in the embodiments described above may be implemented by running a program provided in advance on a computer system such as a personal computer or a workstation. In view of this, an example of a computer system capable of executing a program having similar functions to those of the embodiments described above will be described below. FIG. 11 is a diagram illustrating a computer that executes a production plan support program.

As illustrated in FIG. 11, a computer 300 includes a CPU (Central Processing Unit) 310, an HDD (Hard Disk Drive) 320, and a RAM (Random Access Memory) 340. These units 300 to 340 are connected together via a bus 400.

A production plan support program 320a which provides the same functions as those of the foregoing acceptance unit 40 and the display control unit 41 is stored in the HDD 320 in advance. Note that the production plan support program 320a may be divided into pieces as necessary.

The HDD 320 stores various types of information. For example, the HDD 320 stores the OS or various types of data used in production plans.

Then, the CPU 310 reads the production plan support program 320a from the HDD 320 and executes the production plan support program 320a, to perform the same operations as those of the processing units according to the foregoing embodiment. In other words, the production plan support program 320a performs the same operations as those of the acceptance unit 40 and the display control unit 41.

Note that the production plan support program 320a described above does not necessarily need to be stored in the HDD 320 from the beginning.

For example, the program may be stored in a “portable physical medium” to be inserted into the computer 300, such as a flexible disk (FD), a CD-ROM, a DVD disk, a magneto-optical disk, and an IC card. The computer 300 may read the program from such a medium and execute the program.

The program may be stored in “another computer (or server)” or the like connected to the computer 300 via a public line, the Internet, a LAN, a WAN, or the like. The computer 300 may read the program from such a computer (or server) and execute the program.

According to an aspect of the present invention, it is possible to easily grasp the production plans of the production steps for performing the work of an order.

All examples and conditional language provided herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium having stored therein a program that causes a computer to execute a production plan display process comprising:
controlling a first display of arranging a plurality of production processes included in production processing of a particular product in an order of execution, the arrangement being associated with an order to produce the particular product, and at the same time, controlling a second display of arranging, for each production line planned to be used in the production processing of the particular product, each of production processes planned to be executed on a subject production line among the plurality of production processes at a time position corresponding to a time position where the production process is arranged in the first display.

2. A non-transitory computer-readable recording medium having stored therein a program that causes a computer to execute a production plan support process comprising:
supporting in making a production plan for a factory including a plurality of facilities;
when an instruction to display production information for order information for production of a certain product by using a diagram in which start date and time and end date and time of work of each process are expressed by an area with one axis serving as a time axis is detected, referring to a storage, wherein based on the order information for the production of the certain product, work for producing the certain product is divided into a plurality of processes, and the storage stores a facility and a time slot to be used to perform respective pieces of work of the plurality of processes; and
arranging each of the plurality of processes for producing the certain product for the order information in the diagram, extracting and arranging each of lines on which the plurality of processes are performed, and outputting a result of arrangement.

3. The non-transitory computer-readable recording medium according to claim 2, the outputting includes extracting and displaying lines to which the respective processes are assigned when an instruction to display an assignable facility is detected.

4. A production plan display method comprising:
controlling a first display of arranging a plurality of production processes included in production processing of a particular product in an order of execution, the arrangement being associated with an order to produce the particular product, and at the same time, controlling a second display of arranging, for each production line planned to be used in the production processing of the particular product, each of production processes planned to be executed on a subject production line among the plurality of production processes at a time position corresponding to a time position where the production process is arranged in the first display, by a processor.

5. A production plan support method comprising:
supporting in making production plans for a factory including a plurality of facilities, by a processor;
when an instruction to display production information for order information for production of a certain product by using a diagram in which start date and time and end date and time of work of each process are expressed by an area with one axis serving as a time axis is detected, referring to a storage, wherein based on the order information for the production of the certain product, work for producing the certain product is divided into a plurality of processes, and the storage stores a facility and a time slot to be used to perform respective pieces of work of the plurality of processes, by the processor; and
arranging each of the plurality of processes for producing the certain product for the order information in the diagram, extracting and arranging each of lines on which the plurality of processes are performed, and outputting a result of arrangement, by the processor.

6. A production plan display apparatus comprising:
a processor that executes a process including:
controlling a first display of arranging a plurality of production processes included in production processing of a particular product in an order of execution, the arrangement being associated with an order to produce the particular product, and at the same time, controlling a second display of arranging, for each production line planned to be used in the production processing of the particular product, each of production processes planned to be executed on a subject production line among the plurality of production processes at a time position corresponding to a time position where the production process is arranged in the first display.

7. A production plan support apparatus comprising:
a processor that executes a process including:
supporting in making production plans for a factory including a plurality of facilities;
when an instruction to display production information for order information for production of a certain product by using a diagram in which start date and time and end date and time of work of each process are expressed by an area with one axis serving as a time axis is detected, referring to a storage, wherein based on the order information for the production of the certain product, work for producing the certain product is divided into a plurality of processes, and the storage stores a facility and a time slot to be used to perform respective pieces of work of the plurality of processes; and
arranging each of the plurality of processes for producing the certain product for the order information in the diagram, extracting and arranging each of lines on which the plurality of processes are performed, and outputting a result of arrangement.
